(19) United States
(12) Patent Application Publication
(10) Pub. No.: US 2026/0002408 A1
(43) Pub. Date: Jan. 1, 2026

(54) ARMORED SECURITY ROLLER SHUTTER

(71) Applicant: Arnon BARAK, Haifa (IL)

(72) Inventor: Arnon BARAK, Haifa (IL)

(21) Appl. No.: 19/253,865

(22) Filed: Jun. 29, 2025

(30) Foreign Application Priority Data
Jun. 30, 2024 (IL) 314030

(51) Int. Cl. E06B 9/11; E06B 5/11; E06B 9/15

(52) U.S. Cl. CPC E06B 9/11; E06B 5/11; E06B 2009/1505; E06B 2009/1544

(57) ABSTRACT

A slat for use in a roller shutter has an elongated body. The elongated body has an upper engaging arrangement in an upper portion thereof, and, a lower engaging arrangement in a lower portion thereof. The body is provided with at least one chamber having at least one bar. The at least one bar of a given slat has a vertical overlap with the at least one bar of the slat that is engaged with the given slat and upwardly therefrom. When the slat has a first bar within an upper chamber and a second bar within a lower chamber, the first bar overlaps with the second bar in a lengthwise direction along an internal overlap.

### FIELD OF THE INVENTION

The present invention relates to the field of roller shutters, and more particularly to the field of armored security roller shutters.

### BACKGROUND OF THE INVENTION

Roller shutters are widely used for closing apertures in structures such as windows in walls, and also entrance openings that extend from the floor up. The roller shutters are formed of horizontally extending slats that are engaged into each other. When the roller shutter is rolled-up, by a manually-operated strap or by an electrical motor, each slat pulls up the slat that is connected below. In that manner, the entire shutter is rolled into a roll that is located above the shutter. The roll may be rolled into an external box or into an internal box.

During the lifting of the shutter, from a closed position into an opened position or into a semi-opened position, that is a position between the closed position and the opened position, light and air may pass between two adjacent slats by means of spaced-apart perforations that are formed along the length of the connection portion between two adjacent slats.

In many cases, the slats are made of plastic which is a sufficient solution for a variety of applications, being cheap and light material. When it is desired to give extra burglary protection to the roller shutter, a few actions may be taken; (1) the spaced-apart perforations may be omitted so that insertion of a burglary tool or a wire through the perforations is prevented. (2) instead of being made of plastic, the slats may be made of aluminum, which is a much sturdier material than plastic and has better resistance against deterioration and fatigue braking, and, also, against braking, e.g., by a hammer or a crowbar, or against pushing, bending, and removing out of the vertical guiding track of the roller shutter. (3) sometimes, for even extra protection, a solid steel bar, typically of a square cross-section is inserted into some or all of the slats, for providing an additional protection against braking and pushing out of the tracks.

In some cases, such as, e.g., large openings in factories or sensitive plants, the slats are made of steel and are formed as a large grate. Despite the structure being strong and though, it may be pulled out of the tracks by tying a rope or steel cable to the grate and forcibly pulling the grate out. Also, despite the fact that the shutter does not provide any visual protection to the inside, the slats may be easily cut by a dedicated tool such as a portable and rechargeable cutting disc.

It is the object of the present invention to provide a roller shutter that significantly reduces or overcomes the aforementioned disadvantages.

It is a further object of the present invention to provide an armored roller shutter that provides better burglary protection than known roller shutters and that it is very difficult to be broken, cut, bent or passing therethrough.

### SUMMARY OF THE INVENTION

The present invention includes an armored security slat for being used in a roller shutter.

According to the present invention there is provided a slat for being used in a roller shutter, the slat comprising:
an elongated body having upper engaging arrangement in an upper portion thereof, and, lower engaging arrangement in a lower portion thereof,
the body is provided with at least one chamber, wherein
the at least one chamber comprises at least one bar.

Typically, the at least one bar extends along an entire length of the slat.

Practically, the at least one chamber comprises at least two grooves for receiving therein the at least one bar.

Typically, the upper engaging arrangement comprise an inwardly directed upper hook,
the lower engaging arrangement comprise an outwardly directed lower hook, and wherein
a downwardly directed open end of the upper hook constitutes an upper hook abutment surface, and
an upwardly directed inner portion of the lower hook constitutes a lower hook abutment surface.

Advantageously, when the slats are assembled to a rolling shutter
the at least one bar of a given slat has a vertical overlap with the at least one bar of the slat that is engaged with the given slat and upwardly therefrom.

Practically, the body comprises an upper chamber that is separated from a lower chamber by a central partition.

Advantageously, a lengthwise direction is defined as a direction from the upper portion of the slat to the lower portion of the slat, and wherein
the upper chamber overlaps with the lower chamber in a lengthwise direction along a first overlap extension.

Typically, the upper chamber comprises a first bar, and
the lower chamber comprises a second bar.

Advantageously, the first bar overlaps with the second bar in a lengthwise direction along an internal overlap.

Further advantageously, when the slats are assembled to a rolling shutter, the first bar of a given slat has a vertical overlap in a lengthwise direction with the second bar of a slat that is engaged with and located upwardly the given slat.

Practically, the first bar is held within the upper chamber between a first groove and a second groove, and
the second bar is held within the lower chamber between a third groove and a fourth groove.

If desired, the at least one bar has a rectangular cross-section.

Further if desired, the at least one bar is made of steel.

### BRIEF DESCRIPTION OF THE DRAWINGS

For a better understanding of the present invention and to show how the same may be carried out in practice, reference will now be made to the accompanying drawings, in which:

FIG. 1 is a side cross-sectional view of a slat according to the present invention shown without the metal bars installed inside;

FIG. 2 is a side cross-sectional view of a slat according to the present invention, with the metal bars installed inside;

FIG. 3 is an isometric view of a portion of a roller shutter according to the present invention, shown in a partial sectional view of the middle slat;

FIG. 4 is a side cross-sectional view of the roller shutter of FIG. 3 shown in a fully closed position; and

FIG. 5 is a side cross-sectional view of the roller shutter of FIG. 4 shown in a semi-closed position.

### DESCRIPTION OF PREFERRED EMBODIMENTS

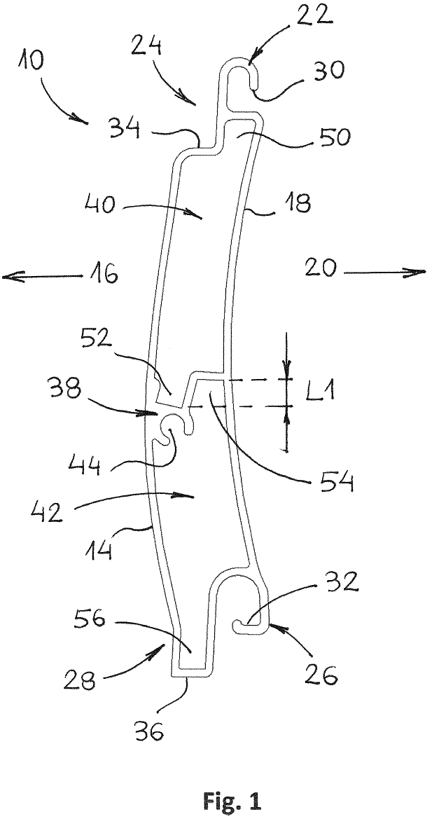

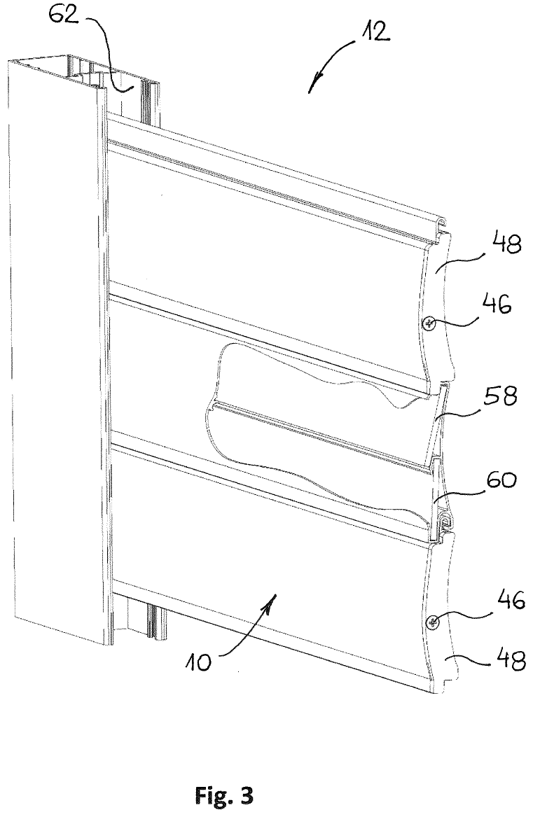

Attention is first drawn to FIG. 1 that show a slat 10 according to the present invention, forming a part of a roller shutter 12 (see FIG. 3). The slat 10 has an external portion 14 that faces an outward direction 16 and an internal portion 18 that faces an inward direction 20. Typically to slats of roller shutters, the external portion 14 of the slat 10 is slightly convex and the internal portion 18 of the slat 10 is slightly concave to enable easy and effective rolling of the slats into a roll (not shown) having a minimal diameter.

The outward direction 16 and the inward direction 20 are defined with respect to the opening that the roller shutter 12 is intended to close. Thus, e.g., if the roller shutter 12 closes a window in a building, then, an outward direction 16 means outwardly from the building, and, an inward direction 20 means into the building.

The slat 10 has an inwardly directed upper hook 22, being upper engaging arrangement, in an upper portion 24 of the slat 10, and, an outwardly directed lower hook 26, being lower engaging arrangement, in a lower portion 28 of the slat 10. Each upper hook 22 of a given slat 10, except of the upper hook 22 of an uppermost slat 10 that is connected to a rolling bar (not shown) of the roller shutter 12, is engaged with and hanged from a lower hook 26 of a slat 10 located above the given slat 10.

A downwardly directed open end of the upper hook 22 constitutes an upper hook abutment surface 30. An upwardly directed inner portion of the lower hook 26 constitutes a lower hook abutment surface 32.

The slat 10 has an upper abutment surface 34 located in the upper portion 24 of the slat 10, and, a lower abutment surface 36 located in the lower portion 28 of the slat 10.

The slat 10 comprises two distinct chambers that are separated by a central partition 38. An upper chamber 40 extends from the central partition 38 to the upper portion 24 of the slat 10, and, a lower chamber 42 extends from the central partition 38 to the lower portion 28 of the slat 10.

The central partition 38 is provided with an open hole 44 for receiving therein a screw 46 for securing in place a cap 48 (see FIG. 3). As shown, each cap 48 closes a side of a slat 10 and both sides of each slat 10 are closed with caps.

An upper end of the upper chamber 40 is provided with a downwardly facing first groove 50, and, a lower end of the upper chamber 40 is provided with an upwardly facing second groove 52. An upper end of the lower chamber 42 is provided with a downwardly facing third groove 54, and, a lower end of the lower chamber is provided with an upwardly facing fourth groove 56.

As can be seen in a side view of the slat 10, the second groove 52 overlaps with the third groove 54 in a lengthwise direction along a first overlap extension L1. The lengthwise direction is defined as a direction from the upper portion 24 of the slat 10 to the lower portion 28 of the slat 10.

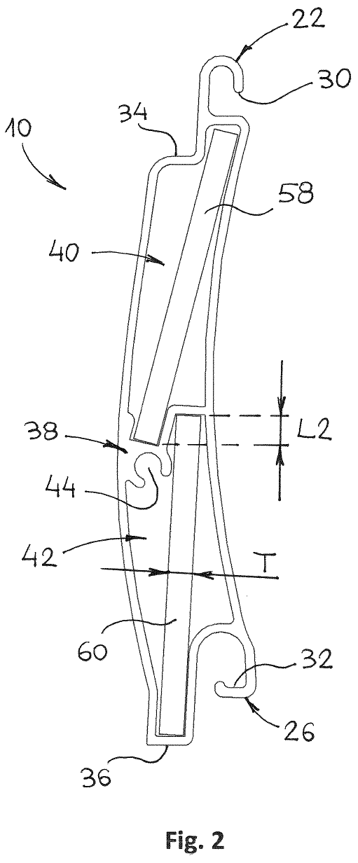

As can be seen in FIG. 2, a bar, typically a metal bar, is installed in each of the chambers of the slat 10. A first bar 58 is installed in the upper chamber 40, and, a second bar 60 is installed in the lower chamber 42. Each of the first bar 58 and the second bar 60 has a rectangular cross-section and extends along an entire length of the slat 10.

Each of the first bar 58 and the second bar 60 is made of a thin steel plate having a thickness T. The thickness T is determined according to specific needs of the roller shutter 12, length of the slats 10, height of the roller shutter 12, internal and external design constraints, specific protection needs, motor capacity, bar material, and budget constraints. Thus, according to specific requirements of the roller shutter 12, the thickness T, and hence the design of the slat 10, may vary considerably. According to specific embodiments of the present invention, the thickness T is 2.5 mm.

The design of the internal dimensions of the upper chamber 40 and of the lower chamber 42 is such that it enables free insertion of the bars into the slat 10 from its side during an assembling process of the slat 10. Thus, the first bar 58 is slid into the upper chamber 40, and, the second bar 60 is slid into the lower chamber 42. When the first bar 58 and the second bar 60 are completely inserted into their respective upper chamber 40 and lower chamber 42, the slat 10 is covered by a cap 48 from each of its sides. Each of the caps 48 is secured by a screw 46, screwed into its corresponding hole 44, for preventing unintentional sliding of the first bar 58 and the second bar 60 out of the slat 10. The closing by the caps 48 also creates sealing of the upper chamber 40 and the lower chamber 42, and provides nice and smooth finishing to the ends of the slat 10.

In an assembled position of the slats 10, each slat 10 is engaged with its adjacent slat 10, and they all run within a vertical guiding track 62 positioned in each end of the slats 10 of the roller shutter 12. In FIG. 3, for clarity of description, only one guiding track 62 is shown.

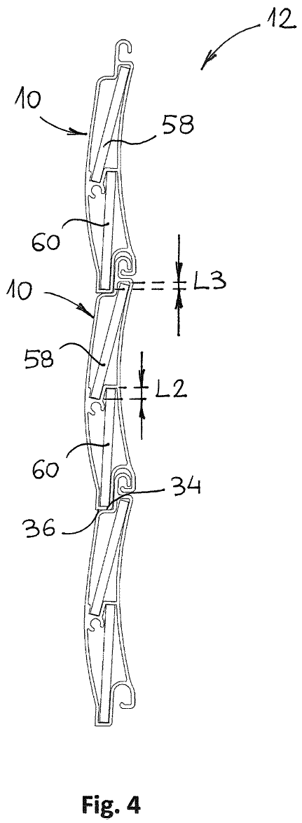

FIG. 4 shows a cross-sectional view of a portion of the roller shutter 12 in a fully closed position. In this position, a lower slat 10 of the roller shutter 12 rests on a lower end (not shown) of the opening, e.g., a window, that is being closed by the roller shutter 12. Hence, in this position, each slat 10 rests, along its entire length, on the slat 10 that is engaged below.

As shown in FIG. 4, each first bar 58 of a given slat 10 overlaps with the second bar 60 of the same slat 10 an internal overlap L2 in a lengthwise direction. Furthermore, each first bar 58 of a given slat 10 overlaps with a second bar 60 of an adjacent upper slat 10 an external overlap L3 in a lengthwise direction. The lengthwise direction is defined as a direction from the upper portion 24 of the slat 10 to the lower portion 28 of the slat 10.

When the guiding track 62 of the roller shutter 12 is positioned vertically, as is the case in the majority of uses of the roller shutter 12, then, the first overlap extension L1, the internal overlap L2, and, the external overlap L3 are measured vertically.

As shown in FIG. 4, in a fully closed position of the roller shutter 12 when each slat 10 rests, along its entire length, on the slat 10 that is engaged below, the lower abutment surface 36 of a given slat 10 abuts the upper abutment surface 34 of the slat 10 that is engaged below.

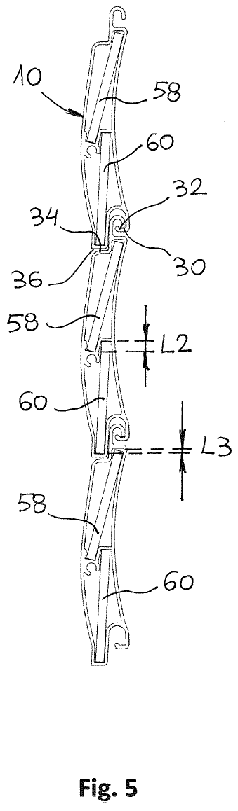

FIG. 5 shows a cross-sectional view of the roller shutter 12 in a semi-closed position. In this position, the roller shutter 12 is in an intermediate position between a fully opened position and a fully closed position. During a closing stage, it means that the slats 10 move downwardly and each slat 10 hangs from the slat 10 that is located above it. In this position, the upper hook abutment surface 30 of a given slat 10 abuts against the lower hook abutment surface 32 of the slat 10 that is located above it. Furthermore, in this position, the upper abutment surface 34 of a given slat 10 is not in abutment with the lower abutment surface 36 of the slat 10 that is engaged with and connected above the given slat 10.

During an opening stage, being also a semi-closed position, it means that the slats 10 start moving up from a fully closed position. Like during a closing stage, during the opening stage the upper hook abutment surface 30 of a given slat 10 abuts against the lower hook abutment surface 32 of the slat 10 that is located above it. Furthermore, in this position, the upper abutment surface 34 of a given slat 10 is not in abutment with the lower abutment surface 36 of the slat 10 that is engaged with and connected above the given slat 10.

As can be seen in FIGS. 4 and 5, in a fully closed position of the roller shutter 12, and, in a semi-closed position of the roller shutter 12, a major advantage of the present invention is that there is overlap in a lengthwise direction of all the bars withing the slats 10. Thus, practically, there is always an internal overlap L2 between a first bar 58 and a second bar 60 in any given slat 10. Furthermore, practically, there is always an external overlap L3 between any first bar 58 of a given slat 10 and a second bar 60 of the slat 10 that is engaged with and located above the given slat 10. The use of the term “practically” refers to the fact that the internal overlap L2 and the external overlap L3 are sufficiently large to enable adequate mechanical protection of the slats 10 of the roller shutter 12.

Thus, as explained above, the roller shutter 12 according to the present invention provides fully overlapping of the bars within the slats 10, thus adding to the rigidity and stiffness of the roller shutter 12. Furthermore, the combination of aluminum slats with steel bars makes more difficult any breaking attempts of the roller shutter.

In some cases, when it is desired to enable some light and air to pass through the opening closed by the roller shutter 12 while still enabling adequate protection, then, the ends of the lower slat 10 or of an upper slat 10 (not shown), may be locked into the guiding track 62 in a manner that does not form a part of the present invention.

In some cases, when it is desired to lock the rolling shutter 12 in a fully closed position, the ends of a lower slat 10 or of an upper slat 10 (not shown), may be locked into the guiding track 62 in a manner that does not form a part of the present invention.

Although the present invention has been described to a certain degree of particularity, it should be understood that various alterations and modifications could be made without departing from the spirit or scope of the invention as hereinafter claimed.

The bars do not have to be formed from steel plates. Alternatively, the bars may be formed from hardened steel plates, Kevlar, stainless steel, ceramic, composite materials, or any other metal or material that will suit the needs of a specific roller shutter.

Depending on the material the bars are made of, the slat according to the present invention may provide a limited protection against bullets.

The guiding tracks do not have to be installed vertically. According to some embodiments, the guiding tracks are installed at an acute angle to a vertical position, typically less than 45-degrees, providing that the self-weight of the slats will enable their sliding downwardly and closing of the roller shutter.

In some cases, not all the slats are provided with bars.

In some cases, not all the slats are provided with two bars and some of the slats may be provided with one bar only, being a first bar or a second bar.

The slat does not have to be formed with two chambers, i.e., an upper chamber and a lower chamber. Alternatively, the slat may be formed with one chamber only and having a single bar inside it, or, the slat may be formed with more that two chambers, where some or all of the chambers are provided with bars inside them.

Not all the bars have to be seated withing specific grooves. Alternatively, the bars may be seated freely within a chamber, or, restricted to a specific location/position within a chamber.

A given chamber does not have to contain one bar only. Alternatively, a given chamber may contain more than one bar.

The arrangement of the bars within a slat is not limited to the arrangement shown in the description, where a lower portion of the first bar is located outwardly with respect to an upper portion of the second bar. Alternatively, the slat may be arranged differently, such that a lower portion of the first bar is located inwardly with respect to an upper portion of the second bar.

The slat does not have to be formed with an upper hook and a lower hook as described. According to some embodiments, an upper portion of a given slat is connected to a lower portion of an upper slat in an alternative manner, e.g., the upper portion of the slat is provided with lengthwise extending rings that are positioned intermittently with respect to rings provided in the lower portion of the slat. In order to connect two adjacent slats, a rod, having a round cross-section, is inserted through the set of rings of an upper portion of a slat and the set of rings of a lower portion of the slat engaged from above the given slat.

1. A slat for being used in a roller shutter, the slat comprising:
an elongated body having upper engaging arrangement in an upper portion thereof, and, lower engaging arrangement in a lower portion thereof,
the body is provided with at least one chamber, wherein
the at least one chamber comprises at least one bar.

2. The slat according to claim 1, wherein
the at least one bar extends along an entire length of the slat.

3. The slat according to claim 1, wherein
the at least one chamber comprises at least two grooves for receiving therein the at least one bar.

4. The slat according to claim 1, wherein
the upper engaging arrangement comprise an inwardly directed upper hook,
the lower engaging arrangement comprise an outwardly directed lower hook, and wherein
a downwardly directed open end of the upper hook constitutes an upper hook abutment surface, and
an upwardly directed inner portion of the lower hook constitutes a lower hook abutment surface.

5. The slat according to claim 1, wherein when the slats are assembled to a rolling shutter
the at least one bar of a given slat has a vertical overlap with the at least one bar of the slat that is engaged with the given slat and upwardly therefrom.

6. The slat according to claim 1, wherein
the body comprises an upper chamber that is separated from a lower chamber by a central partition.

7. The slat according to claim 6, wherein
a lengthwise direction is defined as a direction from the upper portion of the slat to the lower portion of the slat, and wherein
the upper chamber overlaps with the lower chamber in a lengthwise direction along a first overlap extension.

8. The slat according to claim 7, wherein
the upper chamber comprises a first bar, and
the lower chamber comprises a second bar.

9. The slat according to claim 8, wherein
the first bar overlaps with the second bar in a lengthwise direction along an internal overlap.

10. The slat according to claim 8, wherein
when the slats are assembled to a rolling shutter, the first bar of a given slat has a vertical overlap in a lengthwise direction with the second bar of a slat that is engaged with and located upwardly the given slat.

11. The slat according to claim 8, wherein
the first bar is held within the upper chamber between a first groove and a second groove, and
the second bar is held within the lower chamber between a third groove and a fourth groove.

12. The slat according to claim 1, wherein
the at least one bar has a rectangular cross-section.

13. The slat according to claim 1, wherein
the at least one bar is made of steel.
